(19) United States
(12) Patent Application Publication
(10) Pub. No.: US 2006/0154850 A1
(43) Pub. Date: Jul. 13, 2006

(54) Fragrance compositions

(75) Inventors: Christian Quellet, Bienne (CH); Sandrine Dumas Krikorian, L'Isle Adam (FR); Olga Gey, Duebendorf (SZ); Alice Bresson, Sannois (FR)

Correspondence Address: NORRIS, MCLAUGHLIN & MARCUS, 875 THIRD AVE, 18TH FLOOR, NEW YORK, NY, 10022, US

(73) Assignee: Givaudan SA, Vernier (CH)

(21) Appl. No.: 10/542,315

(22) PCT Filed: Jan. 26, 2004
(86) PCT No.: PCT/CH04/00039

§ 371 Date: Jul. 13, 2005

(30) Foreign Application Priority Data
Jan. 24, 2003 (GB) 0301662.3

(51) Int. Cl. A61Q 13/00

(52) U.S. Cl. 512/2

(57) ABSTRACT

A fragrance composition useful for imparting fragrance to a surface comprises water, a fragrance material, a liquid crystal-forming material containing at least one fatty alcohol having at least 22 carbon atoms, and a reinforcing material. The compositions are unusually storage-stable, even at high temperatures.

The present invention is concerned with fragranced household and personal care products such as detergents and conditioners, cleansing products and cosmetic products, which may be applied to a surface to be treated and impart a long-lasting freshness thereto.

Imparting fresh fragrance accords to surfaces, such as fabrics, solid surfaces, or to hair and skin poses considerable problems for formulators. Firstly, fragrance materials are often complex mixtures of ingredients having disparate physicochemical properties such as volatility, solubility and chemical reactivity. Interactions of any of these ingredients within household and personal care product bases may interfere with the performance of the fragrance material. For example, fragrance components may be degraded by, dispersed in, or evaporate from these products thereby reducing the impact, or altering the tonality, of the fragrance material during storage and use.

In order to address these problems, formulators have worked on the principle of separation of the fragrance material from the consumer or household product composition by providing a suitable delivery vehicle for the fragrance material. Typical of such methodology is encapsulation of the fragrance material. However, whereas many encapsulating media are successful in protecting the fragrance material from the deleterious effects mentioned above, very often the encapsulating media interferes with the performance of the fragrance material. For example, it may not release the fragrance material in a desired manner, or it may not deposit substantively on a surface. It is not surprising therefore that many such systems are poorly regarded in consumer studies.

There remains a need to provide encapsulating media that not only protect fragrance materials from the deleterious effects of prolonged exposure to household and consumer product ingredients, but also permit the release of fragrance slowly at room temperature to impart a prolonged fresh feeling to treated surfaces, and which also are capable of permitting a burst of fragrance at high temperatures, e.g. during ironing, or as a result of mechanical action, e.g. frictional engagement when the treated surface is rubbed or wiped.

Surfactants capable of forming liquid-crystalline structures have been used in detergent products. For the most part, such materials have been employed for their surfactant properties, or for their texturing or Theological properties (see U.S. Pat. No. 5,696,074 or U.S. Pat. No. 5,958,431 ); or as thickeners (see WO 97/00667).

However, EP 0 466 235 A1 discloses the use of such materials to form ordered liquid-crystalline structures around dispersed fragrance droplets, thereby to encapsulate them and so enhance the performance of the fragrance.

Despite the realisation that liquid-crystalline materials may be employed to deposit fragrance materials on fabrics, such materials have not been successfully commercially exploited in liquid consumer products. At this time, customer acceptance of such materials is low because the liquid-crystalline structures are thermally unstable. This is particularly a problem when they are dispersed in aqueous products, and in particular in such products containing surfactants. In such products, particularly at high storage temperatures, e.g. at about 40° C. or higher, the liquid crystalline structures tend to break up or dissolve with concomitant loss of fragrance material to the surrounding medium.

Liquid crystalline materials remain interesting media from which to deliver fragrance materials. However there is a clear need to provide them in a form that is stable in a product, and that will reliably deliver a fragrance accord over prolonged periods of time to a treated surface, and which will release fragrance rapidly on demand when heat or friction is applied to the treated surface.

Surprisingly, it has now been found that, if liquid crystalline materials are mixed with certain reinforcing agents, there can be obtained particles that contain liquid crystalline structures that possess extended thermal and mechanical stability, thereby rendering such materials eminently useful as fragrance delivery vehicles in all manner of household and consumer products.

Therefore, the invention provides in a first aspect a fragrance composition comprising water, a fragrance material, a liquid crystal-forming material containing at least one fatty alcohol having at least 22 carbon atoms, and a reinforcing material.

Compositions of the present invention display a thermal stability range greater than that attainable using prior art compositions. Without intending to be bound by any theory, it is believed that the liquid crystal-forming material organises within the particles into lamellar structures, and the reinforcing agent is able to intercalate between layers of these lamellar structures to provide the structures with increased mechanical and thermal stability.

In particular, compositions of the present invention may be stored at temperatures above 40° C., even in aqueous products that contain surfactants, without appreciable fragrance loss. Furthermore, in use in harsh aqueous environments, there is a high level of fragrance retention, because the liquid-crystalline structures are stable and remain essentially intact. This in turn ensures that high amounts of fragrance material are available to be deposited intact on to surfaces.

Once deposited on a surface, structural changes, e.g. fractures, in the liquid-crystalline structures, may be caused by evaporation of water during the drying process, allowing fragrance to be released in a controllable manner. In this way, the user may experience a high impact of fresh fragrance accord for prolonged periods of time. Furthermore, mechanical disruptions may occur in the liquid-crystalline structures when a user frictionally engages the treated surface, allowing bursts of fragrance to emanate from dried surfaces hours and even days after treatment with fragrance material.

A reinforcing material is a compound that may be dissolved or dispersed in a liquid to form a viscoelastic material. Adding a reinforcing material to a liquid-crystalline structure has the consequence of increasing both the store elastic modulus G′, loss elastic modulus G″ and the anisotropic to isotropic transition temperature of the structure. G′ and G″ are rheological parameters that are respectively a measure of the stiffness and the viscosity of material within a viscoelastic system. When submitted to the conditions of a Theological measurement (as described in detail in the Examples), the reinforced structure may behave either like a transient gel or a permanent gel. A transient gel is characterized by a cross-over between a G′>G″ region at relatively low deformation amplitudes, hereinafter referred as “elastic region”, and a G′<G″ region at relatively high deformation amplitudes. Conversely, a permanent gel is characterized by the absence of any cross-over and the persistence of the elastic region at all deformation amplitudes till disruption of the gel occurs.

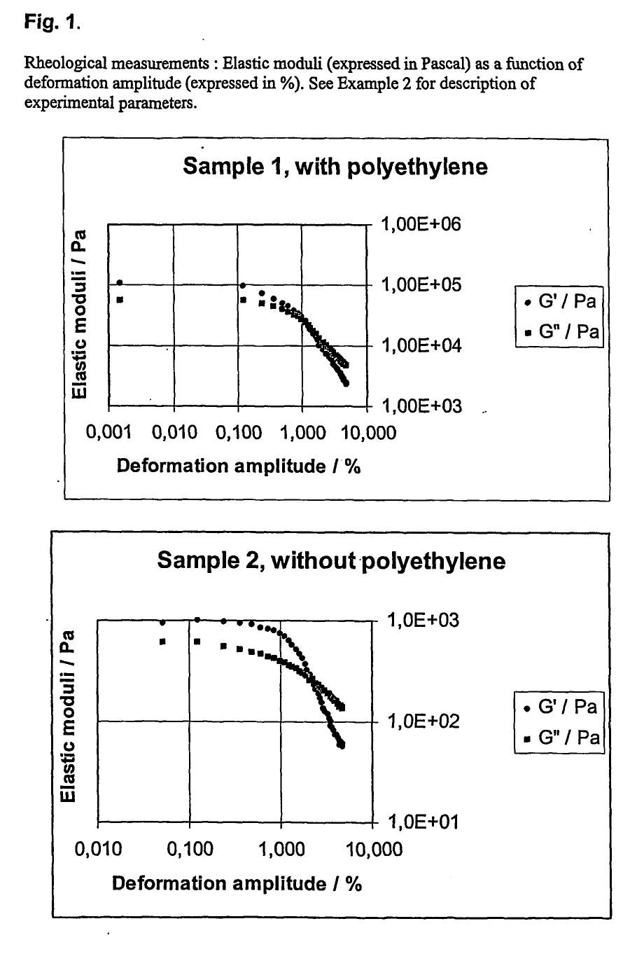

Reinforcing materials in the context of the present invention are those materials that increase the plateau region of the store elastic modulus by at least one order of magnitude compared to compositions containing non-reinforced liquid-crystalline structures. Preferably, reinforced fragrance compositions exhibit a plateau region of the store elastic modulus higher than 10³ Pascal and preferably higher than 10⁴ Pascal at 25° C. (see FIG. 1 and Example 2 for details). The higher the value of the store elastic modulus, the stiffer, therefore the more reinforced, is the material. Furthermore, a material displaying a cross-over point at relatively high deformation amplitudes indicates greater elasticity, compared to materials displaying cross-over points at lower amplitudes.

Reinforcing materials may be selected from organic amphiphilic, hydrophobic, hydrophilic or inorganic materials.

Amphiphilic reinforcing materials may be materials containing hydrophobic and hydrophilic moieties, the ratio of which moieties may vary according to the particular properties sought. Examples of suitable amphiphilic materials are surfactants, associative polymers such as graft and block copolymers, particularly poly(ethylene-b-ethylene oxide), poly(styrene-b-ethylene oxide), and alkyl-modified poly(dimethylsiloxane-g-ethylene oxide. Gelatin and pectin are further examples of biopolymers that can exhibit amphiphilic properties.

Preferred amphiphilic materials are poly(ethylene-b-ethylene oxide) copolymers having an ethylene oxide level preferably lower than 80% and most preferably lower than 50%, and a molecular weight preferably lower than 2500 g/mol and most preferably lower than 1000 g/mol. Typical brands of such copolymers are available under the Trade Mark Peformathox Ethoxylate (ex Baker Petrolite).

Further preferred amphiliphic materials are gelatin, optionally cross-linked with crosslinking agents selected from formaldehyde, glutaric aldehyde or disuccinimido suberate, wherein both reactants are added to the liquid-crystal-forming material and the cross-linking reaction is preferably carried out in situ and after the formation of the liquid crystalline phase. Preferred gelatin has a Bloom strength higher than 250. Bloom strength is defined in British Standard BF 757. Most preferred gelatin is gelatin from porcine skin having a Bloom strength of 300, available, for example, from Sigma Chemie.

Hydrophilic organic reinforcing materials include hydrophilic functional monomers and polymers, optionally combined with cross-linking agents. Examples include acrylamide, N-alkylacrylamide, or any water-soluble multi-functional entities that can form a chemical bond with other reactive entities. Water-soluble polymers include poly((meth)acrylic acid-co-alkyl acrylate) copolymers, e.g. Carbopol™, or copolymers containing poly(acrylamide), poly(vinyl alcohol), poly(alkyleneoxide)moieties, or mixtures thereof, and alginates crosslinked with polyvalent metal ions, such as calcium and aluminium.

A preferred hydrophilic organic reinforcing material is acrylamide crosslinked with N,N-bisacrylamide, wherein both reactants are added to the liquid-crystal-forming material and the cross-linking reaction is preferably carried out in situ, using a suitable catalyst such as azo-di-isobutyronitrile AIBN and after the formation of the crystalline phase.

Especially preferred hydrophilic reinforcing materials are alginates optionally admixed with amphiphilic modified starches or dextrins. Preferred alginates have a 1% solution viscosity lower than 50 mPas when measured in water at 20° C. with a Brookfield viscometer having a spindle number 1 and operating at 60 rpm. Typical brands of such alginates are Grindsted FD 120 and Grindsted LFD 1515, ex Danisco or Kelton LV, ex ISP. Most preferred alginate is Grinsted FD 120. Suitable amphiphilic modified starches and dextrins are octenyl succinate type starch derivatives like Capsul™ and Hi-Cap™ 100 available from National Starch.

Hydrophobic reinforcing materials include monomers optionally combined with cross-linking agents, partially crystallisable polyolefins, block- and graft-copolymers such as styrene-butadiene or styrene-isoprene diblock and triblock copolymers, poly(ethylene-co-dimethylsiloxane) block and graft copolymers, highly crosslinked silicone resins, polysesquiosiloxanes, hydrophobically-modified silicates and aminosilicates, or heat- or lV-curable polymers such as polyacrylates bearing a heat- or light-activated cross-linkable function.

A preferred hydrophobic reinforcing agent is crystalline or partially crystalline polyethylene having a molecular weight lower than 10,000 g/mol and preferably lower than 1000 g/mol, such as those available under the Trade Mark Performalene (ex Baker Petrolite) or ethyl cellulose having Ubbelohde solution viscosities higher than 50 mPas when dissolved at 5% in toluene/methanol at 80/20 by weight and 25° C., such as that commercially available under the trade mark Ethnocel NF 100 (ex Dow Chemical Company).

As inorganic reinforcing agents there may be mentioned silica-containing compounds such as alkyl and alkoxysilanes, and sodium silicate (commercially available in aqueous solution as “water glass”) combined with a salt of a polyvalent metal ion such as calcium and aluminium sulphates.

A preferred inorganic reinforcing material is sodium silicate combined with calcium, in which sodium silicate is added to the liquid-crystal-forming material and the cross-linking reaction is carried out in situ by post-addition of calcium chloride after the formation of the liquid-crystalline phase.

The particular reinforcing material employed will depend upon the structure-forming properties required. For example, materials can be employed that are associated by Van der Waal's forces or lightly cross-linked in order to produce a soft gel. Alternatively, hard, glassy gels can be obtained by employing a highly cross-linked reinforcing material. The skilled person is well aware of the materials needed to form particularly hard, brittle gels or soft gels, or gels having properties intermediate to these extremes.

Reinforcing materials hereinabove described promote the stability of the liquid-crystalline structures at elevated temperatures and may even increase the thermal stability of the structures above the isotropic/anisotropic transition temperature of the particular liquid-crystal-forming material employed. This would ensure that fragrance materials can remain encapsulated with excellent retention at temperatures in excess of 40° C., more particular in excess of 45° C.

In addition, it has surprisingly been found that, by employing a reinforcing material that is inorganic or highly cross-linked, it is possible to obtain very brittle liquid-crystalline structures that, upon drying on a treated surface, will break under shear forces to release fragrance in a burst-like manner. Particularly advantageous reinforcing materials in this respect are colloidal sodium silicate and silane derivatives such as tetra(alkoxy silanes).

The liquid-crystal-forming material may be selected from any of the range of components known in the art to be capable of forming a quasi-crystalline phase or ordered structures in systems containing oil and water. The liquid-crystal-forming material preferably may contain a surfactant that is able to form high melting lamellar phases. High melting lamellar phases are characterised by the existence of one or more melting temperatures above 35° C., preferably above 50° C., and most preferably above 60° C., that may be detected by differential scanning calorimetry according to techniques well known in the art.

In particular, the liquid-crystal-forming material may contain a non-ionic surfactant and long chain fatty alcohols having 16 carbon atoms or more, in which at least one of the long chain fatty alcohols has at least 22 carbon atoms.

The non-ionic surfactant may be selected from

I) alkylglycosides or alkylpolyolosides bearing alkyl chains having at least 20 carbons atoms;

Preferred alkylglycoside-based liquid crystal forming materials are mixtures of alkylglycosides having saturated or unsaturated alkyl residues having at least 20 carbon atoms, and long chain fatty alcohols having at least 16 carbon atoms, such as those available commercially under the trade mark Montanov 202 (ex Seppic);

II) alkylpolysorbates bearing alkyl chains longer than 18 carbon atoms. Preferred alkylpolysorbates are selected from polyethoxylated sorbitan fatty acid esters as disclosed in EP 0 466 235, which is incorporated herein by reference, and their admixtures with sorbitan stearate and long chain linear alcohols having more than 14 carbon atoms. Typical brands of alkylpolysorbates and sorbitan stearates are, respectively, Tween™ 60 and Span™ 60, ex Uniqema. Preferred alkylpolysorbate-based liquid-crystal-forming ingredient are commercially available as mixtures of polysorbate 60 and cetearyl alcohol under the trade mark Polawax NF (ex Croda); and

III) ethoxylated fatty esters with alkyl residue having 18 carbon atoms or more. Preferred fatty ester ethoxylate-based liquid crystal forming materials are polyethylene glycol stearates having 20 ethylene oxide units, as available commercially in admixture with cetearyl alcohol under the trade mark Polawax GP 200 (ex Croda).

Another component of the formulation of the present invention is a fatty alcohol having 22 carbon atoms or more. Preferably this alcohol is selected from those fatty alcohols having alkyl or alkenyl residues having at least 22 carbon atoms. More preferably, the fatty alcohol has a narrow molecular weight distribution, that is, at least 90% of the fatty alcohol employed consists of a single fatty acid residue having 22 or more carbon atoms. Still more preferably, the fatty alcohol employed does not contain any branched alkyl residues at a level higher than 5%. The role of this alcohol is to increase the isotropic/anisotropic transition temperature of the particular liquid crystal forming component employed. Preferred long chain fatty alcohols are 1-docosanol (ex Fluka) and higher analogues.

The fatty alcohol having 22 carbon atoms and more may be present at a level of 10 to 90% by weight, preferably at a level of 30 to 75% by weight and most preferably at a level of 40 to 60% by weight of the liquid crystal forming material.

The X-ray scattering intensity pattern of the composition according to the present invention may exhibit one or more intensity peaks in the scattering vector region, corresponding to typical periodicity lengths ranging from about 30 to 120 Angstroms.

In a preferred composition according to the present invention, the typical periodicity length of the liquid crystalline structure ranges from 40 to 60 Angstroms. A discussion of the X-ray scattering techniques and their application to liquid crystals can be found in D. M. Engelman (1985) Modern Trends of Colloid Sciences, H.-F. Eicke (Ed.), Bikhäuser Verlag Basel which is herein incorporated by reference.

Fragrance material may contain fragrance components selected from natural products such as essential oils, absolutes, resinoids, resins, concretes, and synthetic perfume components such as hydrocarbons, alcohols, aldehydes, ketones, ethers, acids, acetals, ketals and nitriles, including saturated and unsaturated compounds, aliphatic, carbocyclic and heterocyclic compounds. Other examples of odorant compositions which may be used are described in H 1468 (United States Statutory Invention Registration).

Examples of preferred fragrance components are any of those fragrances selected from Aldron, Ambrettolide, Ambroxan, Benzyl Cinnamate, Benzyl Salicylate, Boisambrene Forte, Cedrol Crystals, Cedryl Acetate Crystals, Celestolide/Crysolide, Cetalox, Citronellyl Ethoxalate, Fixal, Fixolide, Galaxolide, Guaiacwood Acetate, Cis-3-Hexenyl Salicylate, Hexyl Cinnamic Aldehyde, Hexyl Salicylate, Iso E Super, Linalyl Benzoate, Linalyl Cinnamate, Linalyl Phenyl Acetate, Methyl Cedryl Ketone, Moskene, Musk, Musk Ketone, Musk Tibetine, Musk Xylol, Myraldyl Acetate, Nerolidyl Acetate, Novalide, Okoumal, Para-Cresyl Caprylate, Para Cresyl Phenyl Acetate Crystals, Phantolid Crystals, Phenyl Ethyl Cinnamate, Phenyl Ethyl Salicylate, Rose Crystals/Rosone, Sandela (Lin), Tetradecanitrile, Thibetolide, Traseolide, Trimofix O, 2-Methyl Pyrazine, Acetaldehyde phenylethyl propyl acetal, Acetophenone, Alcohol C6 (in the following the notation Cn comprises all substances having n carbon atoms and one hydroxyl function), Alcohol C8, Aldehyde C6 (in the following the notation Cn encompasses all isomers having n carbon atoms and one aldehyde function), Aldehyde C7, Aldehyde C8, Aldehyde C9, Nonenylic Aldhyde, Allyl Amyl Glycolate, Allyl Caproate, Amyl Butyrate, Aldehyde anisique, Benzaldehyde, Benzyl Acetate, Benzyl Acetone, Benzyl Alcohol, Benzyl Butyrate, Benzyl Formate, Benzyl Iso Valerate, Benzyl Methyl Ether, Benzyl Propionate, Bergamyl Acetate, Butyl Acetate, Camphor, 3-methyl-5-propyl-2-cyclohexenone, Cinnamic Aldehyde, Cis-3-Hexenol, Cis-3-Hexenyl Acetate, Cis-3-Hexenyl Formate, Cis-3-Hexenyl Iso Butyrate, Cis-3-Hexenyl Propionate, Cis-3-Hexenyl Tiglate, Citronellal, Citronellol, Citronellyl Nitrile, 2-hydroxy-3-methyl-2-Cyclopenten-1-one, Cuminic Aldehyde, Cyclal C, Acetic Acid (cycloheyloxy)-2-propenylester, Damascenone, Damascone Alpha, Damascone Beta, Decahydro Beta Napthyl Formate, Diethyl Malonate, Dihydro Jasmone, Dihydro Linalool, Dihydro Myrcenol, Dihydro Terpineol, Dimethyl Anthranilate, Dimethyl Benzyl Carbinol, Dimethyl Benzyl Carbinyl Acetate, Dimethyl Octenone, Dimetol, Dimyrcetol, Estragole, Ethyl Acetate, Ethyl Aceto Acetate, Ethyl Benzoate, Ethyl Heptoate, Ethyl Linalool, Ethyl Salicylate, Ethyl-2-Methyl Butyrate, Eucalyptol, Eugenol, Fenchyl Acetate, Fenchyl Alcohol, 4-Phenyl-2,4,6-trimethyl 1,3-dioxane, Methyl 2-octynoate, 4-Isopropylcyclohexanol, 2-sec-Butylcyclohexanone, Styralyl acetate, Geranyl nitrile, Hexyl Acetate, Ionone Alpha, Iso Amyl Acetate, Iso Butyl Acetate, Iso Cyclo Citral, Dihydroisojasmone, Iso Menthone, Iso Pentyrate, Iso Pulegol, cis-Jasmone, Laevo Carvone, Phenylacetaldehyde glycerylacetal, carbinic acid 3 -Hexenyl Methyl Ether, 1-methyl-cyclohexa-1,3-diene, Linalool, Linalool Oxide, 2-;ethyl Ethyl Ester Pentanoate, 2,6-Dimethyl-5-heptenal, Menthol, Menthone, Methyl Acetophenone, Methyl Amyl Ketone, Methyl Benzoate, Methyl Cinnamic Aldehyde Alpha, Methyl Heptenone, Methyl Hexyl Ketone, Methyl Para Cresol, Methyl Phenyl Acetate, Methyl Salicylate, Neral, Nerol, 4-tert-Pentyl-cyclohexanone, Para Cresol, Para Cresyl Acetate, Para Tertiary Butyl Cyclohexanone, Para Tolyl Aldehyde, Phenyl Acetaldehyde, Phenyl Ethyl Acetate, phenyl ethyl alcohol, phenyl ethyl butyrate, phenyl ethyl formate, phenyl ethyl iso butyrate, phenyl ethyl propionate, Phenyl Propyl Acetate, Phenyl Propyl Aldehyde, Tetrahydro-2,4-dimethyl-4-pentyl-furan, 4-Methyl-2-(2-methyl-1-propenyl)tetrahydropyran, 5-Methyl-3-heptanone oxime, Styralyl Propionate, Styrene Monomer, 4-Methylphenylacetaldehyde, Terpineol, Terpinolene, Tetrahydro Linalool, Tetrahydro Myrcenol, Trans-2-Hexenal, 4,7-Methano-1H-3A,4,5,6,7,7A-hexahydro-acetate and Viridine.

Precursor of fragrance components may also be provided in fragrance materials in the present invention. Precursors are compounds that, upon cleavage under activating conditions such as light, enzymes, elevated temperature or acidic or alkaline pH-values, provide compounds having fragrance characteristics.

Furthermore, other organoleptic materials may be used in admixture with fragrance ingredients, for example, odour-masking agents, insect repellents and the like.

The fragrance material may contain other ingredients, in addition to fragrance ingredients or other organoleptic materials aforementioned. For example, the droplets may contain oils, apolar polymers, waxes or resins in which the fragrance material or other organoleptics may be dispersed or dissolved.

Examples of suitable oils include known oils used for dispersing or dissolving fragrance materials or other organoleptics in encapsulated fragrance formulations, and include vegetable, animal or mineral oils or mixtures thereof.

Resins include triterpenes produced by polymerization of beta-pinene, hydrogenated rosin or rosin esters, sitosterol derivatives and saturated rosin esters having a melting point higher than 50° C.

Wax may be chosen from those of mineral, vegetal, animal or synthetic origin. Examples include beeswax, hydrogenated oil, fatty acids, ester wax, a mono- or di- or tri- substituted glycerol, the substituents thereof being a saturated or unsaturated organic compound, paraffin, microcrystalline wax, petrolatum wax, alkylsilicones and mixture thereof. In particular, the fragrance material can be admixed with alkyl-modified silicones having alkyl side chains with more than 20 carbon atoms, and a melting temperature higher than 70° C. Surprisingly, the applicant has found that, using alkyl-modified silicone materials, further improve the thermal stability of the composition according to the present invention, as well as the retention and sustained release of volatile components of the fragrance material. As such, if they are used, the alkyl-modified silicones represent a preferred ingredient in the fragrance droplets.

Preferred alkyl-modified silicone wax has alkyl residues with 30 carbon atoms and more and is commercially available under the Trade name AMS C 30 wax (ex Dow Corning).

The fragrance compositions of the present invention are aqueous compositions e.g. in the form of pastes, that may containing 10 to 30% fragrance material, 10 to 50% liquid crystal forming material, 0.5% to 10% of a reinforcing material and 10 to 80% water. The fragrance compositions may contains other oil- or water-dispersible adjuvants commonly employed in oil-in-water systems such as dyes, colourants, preservatives, anti-oxidants and the like.

The fragrance composition of the present invention can furthermore contain a cationic compound, whose function is to enhance the affinity of the composition for substrates such as cotton fabrics, hair and skin. Suitable cationic compounds may be selected from cationic polycarbohydrates such as cationic cellulose, cationic guar derivates and chitosan, quatemized N-heterocycle derivatives such as 1-vinyl-2-pyorolidine, vinyl pyrrolidone and 1-vinyl-3-methylimidazolium chloride, quaternized amines and polyalkylene imines. Preferably, the cationic compound is present at a level of up to 5%, preferably up to 3%, of the liquid crystalline material.

The fragrance compositions are furthermore preferably characterized by the occurrence of a melting transition at a temperature higher than 50° C., as measured by Differential Scanning Calorimetry at a heating rate of 1° C. per minute.

Fragrance compositions of the present invention may be further dispersed in water at room temperature under the action of a high-shear mixer operating at typically 5000 to 20000 rpm, in order to form a dispersion of essentially water-insoluble particles consisting typically of 40 to 60% liquid crystal forming material, I to 20% reinforcing material and 30 to 60% fragrance material, whereas it may be anticipated that a small amount, typically up to 5% by weight, of water may be present in the particle in the form of interstitial water.

Such aqueous dispersions, being of lower viscosity than a paste composition, may be easier to work with, for example if further mixing or spraying steps are to be undertaken.

Alternatively, the fragrance compositions in the forms described above may be dried to form powders, using techniques known in the art. Powders are preferably formed by taking particles of fragrance composition dispersed in water, mixing with hydrocolloids and spray-drying the mixture to form a free flowing powder with a particle size distribution between 50 and 400 micrometers and consisting of a solid matrix material having the microparticles dispersed therein. Preferred hydrocolloids are polysaccharides selected from modified starches, maltodextrines, polyvinyl alcohols, combined with sugars. The spray-dried product can further be agglomerated by conventional techniques such as fluid bed granulation, wet granulation and melt granulation to form a granulated material having particle size ranging from 400 to 1500 micrometers or more, hence making more easy the handling and mixing of said dried forms in powder products, such as laundry care detergents, and controlled dissolution of said dried forms in wash liquors. Optionally additional anionic, zwitterionic or, preferably cationic surfactants can be added to the mixture submitted to spray drying to provide electrically charged water-insoluble particles.

Fragrance compositions described above may be further mixed into household and personal care consumer product bases such as a laundry care or hair care conditioner base, a cleansing composition such as a liquid soap or a shower gel, a liquid detergent, a dishwashing product, a bleach or a hard surface cleaner base or a soap bar base. Such bases are well known in the art and need no further discussion here, Representative examples of such bases may be found in EP 0 466 235 A1 which is herein incorporated by reference.

The level of fragrance material added to the aforementioned consumer products may range from 0.1% to 3% by weight of the consumer product base. Typically, only a part of the total perfume usually added to consumer products may be added in the form of a fragrance material according to the invention. Hence, for example, a consumer product may contain 30% of the total fragrance ingredients in the form of the fragrance composition and 60% of the total fragrance ingredients as free fragrance oil.

The fragrance composition of the present invention may be provided in the form of particles containing liquid-crystalline structure, dispersed in an aqueous phase. The size of the particles may range preferably between 1 and 100 microns, more preferably between 1 and 50 microns and most preferably between 1 and 10 microns.

The fragrance compositions according to the present invention may be formed under a variety of conditions using techniques generally known in the art. In general, an oil phase containing all oil-soluble ingredients and an aqueous phase containing water-soluble ingredients are formed separately before being mixed together at a temperature with a moderate shear propeller operating at typically 20 to 250 rpm, optionally combined with a high-shear mixer operating at typically 10,000 to 20,000 rpm.

More particularly, in a first step, all of the oil-soluble ingredients—with the exception of any oil-soluble cross-linking agents and catalysts—may be mixed together with a fragrance material at a temperature above the melting point of the mixture, for example about 60° to 90° C. Thereafter, an aqueous solution of all the water-soluble ingredients—with the exception of any water-soluble cross-linking agents and catalysts—may be prepared at a temperature comparable to the aforementioned temperature. Finally, the resultant mixture is allowed to cool to room temperature under gentle mixing with a low-shear propeller operating at typically 10 to 50 rpm to form a composition of the present invention. More detailed information regarding the formation of the fragrance compositions is provided in the Examples below.

Optionally, in the case where the reinforcing material is obtained by cross-linking, water-soluble or oil-soluble cross-linking agents or catalysts may be added at any temperature between the temperature of mixing and room temperature after the aforementioned mixture has been made to form the desired reinforced composition.

Cross-linking agents and catalysts may also be added after the fragrance composition has been dispersed in water or in consumer product base and the cross-linking reaction conducted at any temperature between room temperature and the anisotropic to isotropic transition temperature of the fragrance material present in the particulate form.

Using fragrance compositions according to the present invention, it is possible to perfume household and personal care products in a manner wherein fragrance material may be contained in the fragrance composition for several months at high storage temperatures, e.g. 45° C. storage temperature. Even after prolonged storage, products are capable of delivering a high impact, balanced perfume to a surface in a controlled manner for a period of 24 hours or even longer, for example up to 5 days

There now follows a series of non-limiting examples that serve to illustrate the invention.

### EXAMPLE 1

Formation of Fragrance Compositions

A series of fragrance compositions (see Table I below) are formed according to the following methodology:

All oil-soluble ingredients are mixed with a fragrance oil (perfume) at 75° C. in a closed vessel until all ingredients have dissolved.

All water-soluble ingredients are dissolved in water and the aqueous solution heated at 80° C., is added dropwise to the above solution under moderate shear mixing using a home-made propeller mixer operating at 2300 rpm.

Thereafter, the fragrance compositions are allowed to cool to room temperature.

TABLE I

Sample

| | #1 | #2 | #3 | #4 |
|---|---|---|---|---|
| Oil-soluble ingredients | | | | |
| Fragrance oil (1) | 20 | 20 | 20 | 20 |
| POLAWAX NF (ex Croda) | 25 | 12.5 | 10 | 10 |
| 1-DOCOSANOL (ex Fluka) | | 12.5 | 10 | 10 |
| PERFORMALENE 400 (2) | | | 5 | |
| Water-soluble ingredients | | | | |
| Water | 55 | 55 | 55 | 55 |
| Sodium silicate | | | | 5 |

(1) The fragrance oil selected is a equiponderant test mixture comprising essentially volatile fragrance ingredients amyl acetate, eucalyptol, dimethyloctenone, cyclal C, linalool, aldehyde C12 MNA, viridine, terpinol, benzyl acetate, irisone, verdyl acetate, phenyl ethyl alcohol, diphenyl oxide, prunolide, lilial.

(2) crystallisable polyolefine having a molecular weight range of 1000 to 4000 g/mol

(3) available commercially under the use name “water glass” (ex Fluka) and having the formula Na₂O.3SiO₂. In the present case, calcium chloride is added to the fragrance composition at room temperature and allowed to diffuse throughout the composition for 24 hours.

The formulations 1 and 2 are non-reinforced and are comparative examples. The formulations 3 and 4 are reinforced and are compositions of the present invention.

### EXAMPLE 2

Rheology of Reinforced and Non-reinforced Fragrance Composition

Rheological measurements are performed using a Paar Physica Rheometer MCR 300 fitted with a cone-plate measuring unit and operating in the oscillating mode. The characteristics of the cone-plate measuring unit CP25-2 are as follows: shear rate factor: 3 s^{-1/}min-^{-1,} shear stress factor: 12.223 Pa, sample volume: 0.16 cm³, radius of measuring cone: 12.5 mm, angle of measuring cone: 2°, cone truncation: 50 micrometers. The viscoelastic response of the composition, characterized by the store modulus G′, the loss modulus G″, is measured as a function of the deformation amplitude. FIG. 1 shows the increase of elastic moduli induced by the addition of Performalene™ 400, a particularly preferred reinforcing agent according to the present invention.

It can be seen from FIG. 1 that the store elastic modulus of the reinforced composition is considerably higher than the non-reinforced composition, indicating that the former is a much stiffer composition. Addition of polyethylene increases the store elastic modulus value of the plateau by at least one order of magnitude. The new mean value of the plateau store modulus is close to 10⁵ Pa, instead of 10³ for the non-reinforced sample. Furthermore, the cross-over of G′ and G″ in the non-reinforced composition is close to 5% deformation, whereas in the reinforced composition the cross-over is much closer to 1% deformation. This indicates that the reinforced composition is considerably more rigid than the non-reinforced composition.

### EXAMPLE 3

Application in Fabric Conditioner

A standard unperfumed fabric conditioner composition is obtained by dissolving 5% dihydrogenated tallowethyl hydroxyethylmonium ethosulfate) (Rewoquat™ WE 18, ex Degussa) and 0.5% C9-11 Pareth-8 (Neodol™ 91 8E, ex Shell) in deionised water at 65° C. followed by cooling down to room temperature under stirring at 2000 rpm.

The fragrance compositions of Example 1 are dispersed in a standard unperfumed fabric conditioning composition containing using a high shear mixer (Ultraturrax IKA T25 operating at 10000 rpm). The total amount of perfume is 1% in the final mixture. The conditioning compositions are aged at 45° C. for one month before olfactory evaluation against freshly prepared conditioning composition. 1.4 gram of the perfumed fabric conditioning composition is dispersed under stirring in 1 lt. water. Clean cotton towels are rinsed with this solution for 10 minutes and let for line drying.

Olfactory Evaluation on Dry Fabrics

The olfactory impact of the dry fabric is assessed by at least five trained panellists after 24 hours and after five days at room temperature, all compositions are compared to a reference sample (perfume alone). Perfume intensity is ranked according to the following scale:

1=barely noticeable

2 =weak

3=moderate

4=strong

The results of the olfactory evaluation are shown in Table II

TABLE II

| | Fresh sample | Fresh sample | Aged sample | Aged sample |
|---|---|---|---|---|
| Sample | 24 h | 5 days | 24 h | 5 days |
| ref. | 1 | 1 | 0 | 0 |
| #1 | 1.5 | 1 | <1 | 0 |
| #2 | 3 | 1.5 | 1.5 | 1 |
| #3 | 4 | 3 | 3 | 2 |
| #4 | 3.5 | 2.5 | 2 | 1.5 |

It is clear from these data that the inventive compositions 3 and 4 out-perform the free-perfume reference sample and also the samples treated with non-reinforced compositions. Given the brittle nature of the sample 4, fragrance was released by rubbing the towel.

### EXAMPLE 4

Further Examples of Fragrance Compositions With Hydrophobic Reinforcing Agents

The same procedure as in Example 1 is applied but the hydrophobic reinforcing agents are dissolved in the oil phase before the composition is prepared (Table III)

TABLE III

Sample

| | #5 | #6 | #7 | #8 |
|---|---|---|---|---|
| Oil-soluble ingredients | | | | |
| Fragrance oil (as in Example 1) | 20 | 20 | 20 | 20 |
| POLAWAX NF | 10 | 10 | 10 | 10 |
| 1-DOCOSANOL | 10 | 10 | 10 | 10 |
| ETHYLCELLULOSE NF | 2 | | | |
| AMS C 30 (ex Dow Corning) | | 5 | | |
| PERFORMALENE 2000 | | | 2 | |
| PERFORMATHOX 480 (3) | | | | 5 |
| Water-soluble ingredients | | | | |
| Water | 58 | 55 | 58 | 55 |

(3) Block copolymer of polyethylene (C20 to C40) and polyethylene oxide (40 EO units) (ex Petrolite).

Further Examples of Fragrance Compositions With Hydrophilic Reinforcing Agents

The same procedure as in Example 1 is applied but the hydrophilic reinforcing agents are dissolved in the water phase before the composition is prepared (Table IV).

TABLE IV

Sample

| | #9 | #10 | #11 | #12 |
|---|---|---|---|---|
| Oil-soluble ingredients | | | | |
| Fragrance oil (as in Example 1) | 20 | 20 | 20 | 20 |
| POLAWAX NF | 30 | 10 | 10 | 10 |
| 1-DOCOSANOL | 10 | 10 | 10 | 10 |
| PERFORMALENE 400 (2) | | 5 | | |
| Water-soluble ingredients | | | | |
| Water | 30 | 53 | 57.55 | 59.10 |
| Mowiol 4/88 (ex Kuraray) | 10 | | | |
| Gelatin Type A 300 Bloom (ex | | 1 | | |
| Sigma) | | | | |
| Glutaraldehyde | | 1 | | |
| Alginate FD 120 (ex Danisco) | | | 2.45 | |
| Alginate Kelton LV (ex ISP) | | | | 0.4 |
| Capsul (ex National Starch) | | | | 0.5 |

Evaluation in Fabric Conditioner Composition

The same method as in Example 3 is applied, except that, in this case, the rinse cycle is performed in a conventional front-loading washing machine, using a towel weight of 440 g, a water volume of 7.4 L, and a time of 8 m. The termperature used is that of tap water. Evaluation is performed after 1 month's storage at 45° C. (Table V).

TABLE V

| | Aged reference | Aged reference | Aged sample | Aged sample |
|---|---|---|---|---|
| Sample | 24 h | 5 days | 24 h | 5 days |
| #5 | 0 | 0 | 2.2 | 1.3 |
| #6 | 0.2 | 0 | 2.4 | 1.3 |
| #7 | 0.5 | 0.2 | 2.6 | 2.4 |
| #8 | 0.5 | 0.2 | 2.3 | 2.2 |
| #9 | 0.2 | 0 | 2.3 | 0.7 |
| #10 | 0.2 | 0 | 2 | 0.9 |
| #11 | 0.3 | 0 | 3.3 | 1.2 |
| #12 | 0.3 | 0 | 3.2 | 0.8 |

### EXAMPLE 5

Fragrance Compositions Containing Cationic Compound

The same procedure as in Example 1 is applied but the cationic compound is added to the water phase before the fragrance composition is prepared (Table V).

TABLE V

| | Sample | | |
|---|---|---|---|
| | #13 | #14 | #15 |
| Oil-soluble ingredients | | | |
| Fragrance oil (as in Example 1) | 20 | 20 | 20 |
| POLAWAX NF | 10 | 10 | 10 |
| 1-DOCOSANOL | 10 | 10 | 10 |
| PERFORMALENE 400 (2) | 5 | 5 | 5 |
| Water-soluble ingredients | | | |
| LUPASOL P (ex BASF) | 0.6 | | 0.6 |
| REWOQUAT RTM 50 (ex Degussa) | | 0.6 | |
| Chitosan SC23 (ex Orffa-Pomosin) | | | 0.6 |
| Citric acid (ex Fluka) | | | 1.5 |
| Water | 54.4 | 54.4 | 52.3 |

### EXAMPLE 6

Preparation of Spray Dried Fragrance Composition

Powders containing fragrance compositions are prepared by the steps of:

1) Forming a fragrance composition according to the methodology described in Example 1.

2) Dissolving selected water soluble materials, surfactants and hydrocolloids, and optionally perfume oil, (see Table VI) in water at 60° C. in a separate vessel (Feed medium) which is let to cool at room temperature.

3) Dispersing the fragrance composition in solution 2 using a Polytron mixing unit operating at 18500 rpm. The final composition of the powder is given in Table V. The dispersion is sprayed in a conventional spray drying tower (Niro Mobile Minor Atomizer) through a two fluid nozzle, using the following process parameters:

| | | |
|---|---|---|
| Inlet temperature: | 180° | C. |
| Outlet temperature: | 80° | C. |
| Feed rate: | 34.8 | g/min |
| Atomizer speed: | 18000 | rpm |

Table VII shows the composition of the dry material.

TABLE VII

| | Sample | | |
|---|---|---|---|
| | #13 | #14 | #15 |
| Fragrance composition | | | |
| Composition selected from examples | 68.3 | | |
| #1 to 12 (without water) | | | |
| Fragrance oil | | 15.47 | 13.32 |
| POLAWAX NF | | 30.99 | 26.65 |
| CAPSUL | | 5.75 | 4.93 |
| KELTON | | 3.25 | 2.81 |
| Feed medium | | | |
| MALDOTEXTRIN IT-6 | 28.19 | 44.50 | |
| CAPSUL | 3.51 | | |
| Fragrance oil | | | 28.65 |
| MOWIOL 3-83 (ex Clariant) | | | |
| MOWIOL 3-96 (ex Clariant) | | | 20.56 |
| GAFQUAT HS-100 (ex ISP) | | | 1.32 |
| REWOQUAT W-3690 (ex Degussa) | | | 1.32 |
| (ISOPROPANOL) | | | (0.44) |

1. A fragrance composition comprising water, a fragrance material, a liquid crystal-forming material containing at least one fatty alcohol having at least 22 carbon atoms, and a reinforcing material.

2. A fragrance composition according to claim 1 wherein the reinforcing material is selected from organic amphiphilic materials, organic hydrophilic materials, hydrophobic materials, inorganic materials and mixtures thereof.

3. A fragrance composition according to claim 2 wherein the amphiphilic material is selected from at least one of
i) surfactants; graft and block copolymers, preferably poly(ethylene-b-ethylene oxide), more preferably poly(ethylene-b-ethylene oxide) having a ethylene oxide level preferably lower than 80% and a molecular weight lower than 2500 g/mol; poly(styrene-b-ethylene oxide); and poly(dimethylsiloxane-g-ethylene oxide,
ii) gelatine, preferably gelatine having a Bloom Strength higher than 250; and
iii) pectin.

4. A fragrance composition according to claim 2 wherein the hydrophilic organic reinforcing material is selected from at least one of acrylamide, preferably acrylamide crosslinked with N,N-bisacrylamide; N-alkylacrylamide; poly((meth)-acrylic acid-co-alkyl acrylate) copolymers; copolymers containing poly(acrylamide), poly(vinylalcohol), or poly(alkyleneoxide)moieties; and
alginates crosslinked with polyvalent metal ions.

5. A fragrance composition according to claim 2 wherein the hydrophobic reinforcing material is selected from at least one of partially-crystallisable polyolefins, preferably partially-crystallisable polyethylene having a molecular weight lower than 10,000 g/mol; block and graft copolymers; poly(ethylene-co-dimethylsiloxane) block and graft copolymers; highly-crosslinked silicone resins; polysesquiosiloxanes; hydrophobically-modified silicates and amino-silicates;
heat- or UV-curable polymers bearing a heat- or light-activated cross-linkable function; and ethyl cellulose having Ubbelohde solution viscosities higher than 50 mPas when dissolved at 5% in toluene/methanol at 80/20 by weight and 25° C.

6. A fragrance composition according to claim 2 wherein the inorganic reinforcing material is selected from at least one silica-containing compound, preferably at least one of an alkylsilane, an alkoxysilane and sodium silicate combined with a salt of a polyvalent metal ion, preferably sodium silicate combined with calcium.

7. A fragrance composition according to claim 1 wherein the liquid crystal-forming material is a mixture of non-ionic surfactant and at least one long chain fatty alcohol having at least 16 carbon atoms, at least one of which alcohols has at least 22 carbon atoms, the non-ionic surfactant being preferably selected from
I) alkylglycosides or alkylpolyolosides bearing alkyl chains having at least 20 carbons atoms;
II) alkylpolysorbates bearing alkyl chains longer than 18 carbon atoms; and
III) ethoxylated fatty esters with alkyl residue having at least 18 carbon atoms; and
the alcohol having at least 22 carbon atoms being preferably selected from fatty alcohols having a narrow molecular weight distribution such that at least 90% of this fatty alcohol consists of a single fatty acid residue.

8. A fragrance composition according to claim 1 in the form of an aqueous dispersion of particles, the particles containing liquid crystalline structures.

9. A fragrance composition according to claim 1 any of the preceding claims wherein it exhibits a plateau region of the store elastic modulus of higher than 10³ Pa, as measured on a Paar Physica Rheometer MCR 300 fitted with a cone-plate measuring unit and operating in the oscillating mode, with a cone-plate measuring unit CP25-2 having the characteristics: shear rate factor: 3 s⁻¹/min⁻¹, shear stress factor: 12.223 Pa, sample volume: 0.16 cm³, radius of measuring cone: 12.5 mm, angle of measuring cone: 2°, cone truncation: 50 micrometers.

10. A fragrance composition according to claim 1 wherein the composition has a liquid crystalline phase with a periodicity length, as measured by X-ray diffraction of between 30 and 120, preferably between 40 and 60 Angstroms.

11. A fragrance composition according to claim 1 wherein the composition exhibits at least one melting transition at a temperature higher than 50° C.

12. Household product comprising a composition according to claim 1.

13. Personal care product comprising a composition according to claim 1.
